(19) United States
(12) Patent Application Publication
(10) Pub. No.: US 2014/0020282 A1
(43) Pub. Date: Jan. 23, 2014

(54) METHOD AND SYSTEM FOR INTEGRATED BIODIESEL PRODUCTION

(71) Applicants: Paul Lavella, SR., Old Bridge, NJ (US); Paul Pullo, Manhasset, NY (US); Gene V. Pullo, New York, NY (US)

(72) Inventors: Paul Lavella, SR., Old Bridge, NJ (US); Paul Pullo, Manhasset, NY (US); Gene V. Pullo, New York, NY (US)

(21) Appl. No.: 13/555,461

(22) Filed: Jul. 23, 2012

(51) Int. Cl. C10L 1/02; B01J 8/00

(52) U.S. Cl. 44/307; 44/639

(57) ABSTRACT

The present invention relates to an integrated method and system to produce biodiesel from a plurality of assorted feed stocks. The feedstocks are pretreated with degumming, physical refining and glycerolysis. The degumming removes impurities, except free fatty acid (FFA), from the recovered vegetable oil and the animal fats. The physical refining removes the free fatty acid (FFA) by heating the recovered vegetable oil and the animal fats and pulling vacuum to allow separation of boiling points between the oil of the feedstocks and the free fatty acids (FFA). The glycerolysis converts the free fatty acid (FFA) from the physical refining into a single methyl ester (SME). The single methyl ester (SME) is combined with the refined natural oil and unrefined natural oil to form a combined oil feedstock. The combined oil feedstock is subject to transesterification by reacting the combined feedstock oil with a catalyst and a solvent to produce biodiesel and glycerin.

### BACKGROUND OF THE INVENTION

1. Field of the Invention

The present invention is related to an integrated process for the production of biodiesel from various starting feed stocks which is optimized with heat integration to minimize operating costs.

2. Description of Related Art

Integrated processes for the production of biofuels from different starting materials are known. U.S. Patent Application Publication No. 2010/0043281 discloses a process for the production of biofuels starting from refined, raw vegetable oils or used food oil or animal fats. The oils and animal fats are pre-treated to yield dry refined oil. The dry refined oil undergoes transesterification with excess dry alcohols or bioalcohols and subsequent separation into a raw glycerine-based phase and a phase containing mixtures of fatty acid alkyl esters and the excess alcohols or bioalcohols.

U.S. Patent Application Publication No. 2008/0282606 describe a system for producing a biodiesel product from multiple feedstocks including a biodiesel reactor, a decanter, a flash evaporator and a distillation column. Biodiesel stabilizers can be added to the resultant biodiesel to enhance thermal stability.

U.S. Pat. No. 7,871,448 describes production of biodiesel and glycerin from free fatty acid feedstocks. The process includes transesterification of a glyceride stream with alcohol to produce a fatty acid alkyl ester stream. A biodiesel stream is separated from the fatty acid alkyl ester stream by distillation or non-evaporative separation.

It is desirable to provide an improved integrated biodiesel process of multiple feedstocks including pretreatment comprising degumming, physical refining, and glycerolysis and further processing including transesterification, biodiesel purification and glycerin purification.

### SUMMARY OF THE INVENTION

The present invention relates to an integrated method and system to produce biodiesel from a plurality of assorted feed stocks. Suitable feedstocks include refined natural oil, unrefined natural oil, recovered vegetable oil, and animal fats. The feedstocks are pretreated with degumming, physical refining and glycerolysis. The degumming removes impurities, except free fatty acid (FFA), from the recovered vegetable oil and the animal fats. The degumming can include acid washing and bleaching. The physical refining removes the free fatty acid (FFA) by heating the recovered vegetable oil and the animal fats and pulling vacuum to allow separation of boiling points between the oil of the feedstocks and the free fatty acids (FFA). The glycerolysis converts the free fatty acid (FFA) from the physical refining into a single methyl ester (SME). The single methyl ester (SME) is combined with the refined natural oil and unrefined natural oil to form a combined oil feedstock.

The combined oil feedstock is subject to transesterification by reacting the combined feedstock oil with a catalyst and a solvent to produce biodiesel and glycerin. The transesterification can be a two stage continuous process. After each stage the reacted mixture passes through a coalescer to allow the glycerin by product that is generated to be separated by gravity from the biodiesel. Both the lighter biodiesel phase and the denser glycerin contain unreacted solvent. The solvent is removed in a biodiesel purification process and a glycerin purification process.

The separated biodiesel can be washed with acidified water to stop the transesterification reaction from continuing and creating undesirable impurities and to remove the salts that are created as a byproduct from the transesterification process. Preferably the biodiesel can be washed in two stages.

The washed biodiesel can be purified using biodiesel flash (BDF) and biodiesel distillation (BDD). The biodiesel flash (BDF) removes solvent from the biodiesel. In one embodiment, a one stage flash tank system is used in which the mixture of biodiesel and solvent is heated to a temperature where the solvent vaporizes (flashes) out of the biodiesel and is condensed and pumped to a holding vessel. The solvent can be transferred for further solvent purification in a solvent recovery system and recycled to the transesterification process.

In the biodiesel distillation (BDD) the solvent remaining after the biodiesel flash (BDF) is removed. The biodiesel is heated and transferred into a second stage flash tank, which serves as a distillation feed tank, prior to entering a distillation column to remove the last remaining quantities of solvent. The biodiesel is distilled to remove the undesirable impurities to allow the biodiesel to comply with the ASTM Standard 6751.

The method of the present invention can include a solvent recovery process which takes in the recovered solvent from the biodiesel flash (BDF) process and removes water from it that is accumulated from the biodiesel wash process. The water can be sent to a water treatment process to remove any carried over salts and the water is recycled back to the biodiesel wash process.

The glycerin from the transesterification can be purified using the steps of glycerin acidulation/neutralization, glycerin flash (GLF), and glycerin distillation (GLD). In the glycerin acidulation/neutralization, acid is added to the glycerin to enhance the unreacted oil separation from glycerin from the transesterification process. The oil is recovered and recirculated back to the inlet of the transesterification process. The glycerin is neutralized before flowing to the glycerin flash (GLF) where most of the solvent is flashed from the glycerin before the flowing to the glycerin distillation (GLD). The glycerin distillation (GLD) removes the remaining solvent and preferably, the glycerin is purified to become USP Grade (99.7% or greater).

The integrated process was developed to use a wide variety of feedstocks to be cost competitive due to the volatility of pricing of the individual feedstocks. The integrated process is optimized with heat integration to minimize operating costs.

The invention will be more fully described by reference to the following drawings.

### BRIEF DESCRIPTION OF THE DRAWINGS

FIG. 1 is a schematic diagram of integrated biodiesel production system in accordance with the teachings of the present invention.

FIG. 2 is a schematic diagram of a degumming process used in a pre-treatment process of the integrated biodiesel production system.

FIG. 3 is a schematic diagram of a physical refining process used in a pre-treatment process of the integrated biodiesel production system.

FIG. 4 is a schematic diagram of a glycerolysis process used in a pre-treatment process of the integrated biodiesel production system.

FIG. 5A is a schematic diagram of a biodiesel transesterification wash process of the integrated biodiesel production system.

FIG. 5B is a schematic diagram of a biodiesel wash process of the integrated biodiesel production system.

FIG. 6 is a schematic diagram of a glycerin treatment process used in a glycerin purification process of the integrated biodiesel production system.

FIG. 7 is a schematic diagram of a glycerin flash (GLF) process used in a glycerin purification process of the integrated biodiesel production system.

FIG. 8 is a schematic diagram of a glycerin distillation (GLD) process used in a glycerin purification process of the integrated biodiesel production system.

FIG. 9 is a schematic diagram of a biodiesel flash (BDF) process used in a biodiesel purification process of the integrated biodiesel production system.

FIG. 10 is a schematic diagram of a biodiesel distillation (BDD) process used in a biodiesel purification process of the integrated biodiesel production system.

FIG. 11 is a schematic diagram of a solvent recovery process used in the integrated biodiesel production system.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

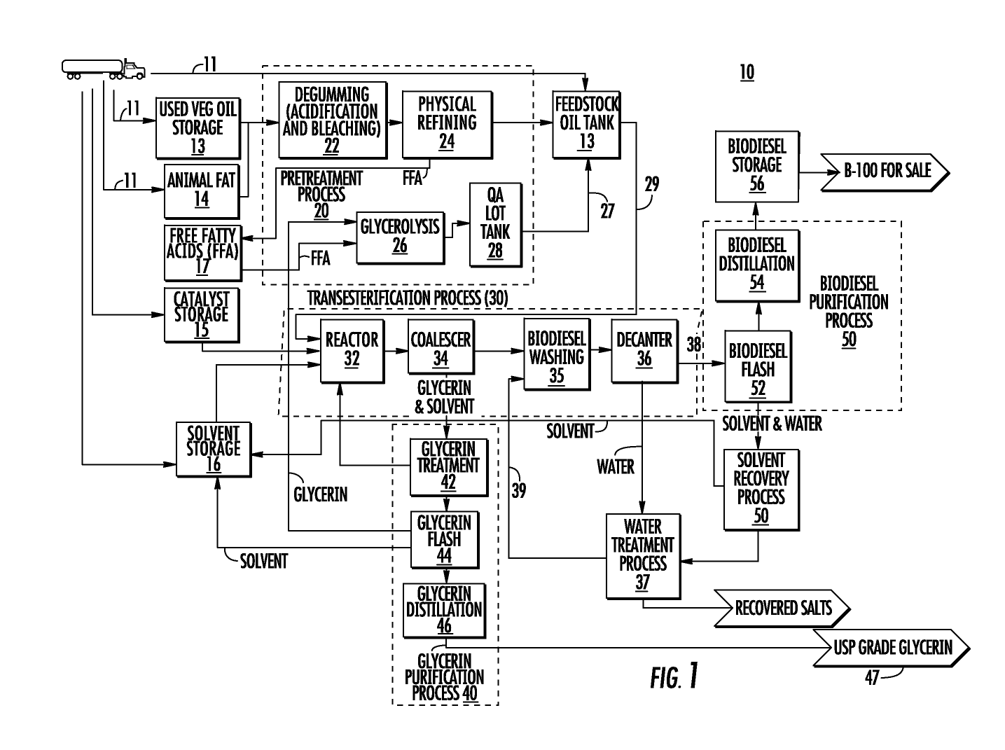

FIG. 1 is a schematic diagram of integrated biodiesel production system 10 in accordance with the teachings of the present invention. Feedstocks 11 can be delivered to system 10. Feedstocks 11 can include refined natural oils, unrefined natural oils, recovered used vegetable oils (UVO) and animal fats. Suitable refined natural oils include single methyl ester (SME) such as soybean, canola, grapeseed, vegetable and others. Refined natural oils and unrefined natural oils can be stored in feedstock oil tank 12. Free fatty acid (FFA) is stored in fatty free acid (FFA) storage tank 17. Used vegetable oils (UVO), such as recovered vegetable or cooking oil, can be stored in used vegetable oil (UVO) storage tank 13. Suitable animal fats include fatty acid methyl esters (FAME), such as, for example, poultry fat, beef tallow, white grease from pork. Animal fats can be stored in animal fat storage tank 14. The catalyst is stored in catalyst storage tank 15. Solvents are stored in solvent storage tank 16.

Pretreatment process 20 converts used vegetable oil (UVO) and animal fats, such as, recovered oils, fats, and greases into a common set of molecules that resemble virgin soybean oil. Pretreatment process 20 includes degumming process 22, physical refining process 24 and glycerolysis process 26. Degumming process 22 removes all impurities except free fatty acid (FFA) from used vegetable oils (UVO) and animal fats. Degumming process 22 can include a two-stage process of acid washing and bleaching. Physical refining process 24 removes free fatty acid (FFA) by heating the oil after degumming process 22 to a high temperature and pulling vacuum to allow a sufficient separation of boiling points between the oil and free fatty acid (FFA). The free fatty acid (FFA) has a lower boiling point and is separated from the oil and sent to glycerolysis process 26. Oil 27, which leaves glycerolysis process 26, is then retained in quality assurance holding tank 28 for analysis prior to being transferred to the feedstock oil tank 12.

Glycerolysis process 26 converts free fatty acid (FFA) from physical refining process 24 through an esterification process into a single methyl ester (SME) by reacting it with recovered glycerin from glycerine purification process 40 and a catalyst in a batch reactor. Upon completion of the reaction and subsequent cooling and decanting of unreacted glycerin, the batch is transferred to QA Lot Tank 27. After passing the QC testing it is then transferred to the feedstock oil tank 12 and is then used in the transesterification process 30.

Feedstock oil 29 from feedstock oil tank 12 is transferred into transesterification process 30. Transesterification process 30 is a continuous process that reacts oil with catalyst from catalyst storage tank 15 and an excess quantity of solvent from solvent storage tank 16. Transesterification process 30 can be performed at an elevated temperature in a two-stage process using reactor 32 and coalescer 34. After each stage, the reacted mixture from reactor 32 passes through coalescer 34 to allow the glycerin byproduct that is generated to be separated from biodiesel by gravity since glycerin is notably denser than biodiesel. Both the lighter biodiesel phase and heavier glycerin phase contain a percentage of unreacted solvent. Glycerin from coalescer 34 is purified in glycerin purification process 40.

Glycerin purification process 40 includes glycerin treatment process 42, glycerin flash (GLF) process 44 and glycerin distillation (GLD) 46. In glycerin treatment process 42, glycerin acidulation and neutralization is performed in which acid is added to enhance the unreacted oil separation from glycerin. The oil is recovered and recirculated back to the inlet of transesterification process 30. Glycerin is then neutralized in glycerin treatment process 42. Glycerin flash (GLF) process 44 can remove solvent from glycerin, for example, in a two-stage flash tank. Glycerin distillation (GLD) 46 can purify glycerin 47, for example, to USP Grade (99.7% or greater).

Biodiesel from coalescer 34 is washed in biodiesel washing process 35. Biodiesel washing process 35 can be performed in two stages with acidified water and water to stop the transesterification from continuing and creating undesirable impurities and to remove the salts that are created as a byproduct from transesterification process 30. Washed biodiesel from biodiesel washing process 35 passes through decanter 36 after each stage where the heavier acidified water phase is allowed to separate from the lighter biodiesel and solvent phase. Acidified wash water from decanter 36 returns to the water treatment process 37 to form a closed loop with biodiesel washing process 35. Additional acid is added to water treatment process 37 to maintain the desired concentration level. Preferably, additional acid is added automatically in water treatment process 37.

Washed biodiesel from decanter 36 forming mixture 38 is fed to biodiesel purification process 50. Biodiesel purification process 50 includes biodiesel flash (BDF) process 52 and biodiesel distillation (BDD) process 54. Mixture 38 from decanter 36 includes biodiesel and solvent. Biodiesel flash (BDF) process 52 can remove the solvent from the biodiesel in a one-stage flash tank system. Mixture 38 of biodiesel and solvent is heated to a temperature where the solvent vaporized (flashes) out of the biodiesel and is condensed and collected in holding vessel 53. Solvent from biodiesel flash (BDF) process 52 is subjected to additional solvent purification in the solvent recovery process 60. Solvent recovery process 60 closes the solvent loop with solvent storage tank 16.

Biodiesel from holding vessel 53 of biodiesel flash (BDF) process 52 enters biodiesel distillation (BDD) process 54. In biodiesel distillation (BDD) process 54, the biodiesel is heated and transferred into a second stage flash tank, which serves as the distillation feed tank, prior to entering the distillation column to remove the last remaining quantities of solvent. The biodiesel is then distilled to remove the undesirable impurities to comply with the ASTM Standard 6751. Biodiesel from biodiesel distillation (BDD) process 54 is stored in biodiesel storage tank 56.

Solvent recovery process 60 takes in the recovered solvent from the biodiesel flash (BDF) process 52 and removes water from it that is accumulated from biodiesel washing process 35. The water is then sent to water treatment process 37 to remove any carried over salts and water 39 is recycled back to biodiesel washing process 35 to close the loop.

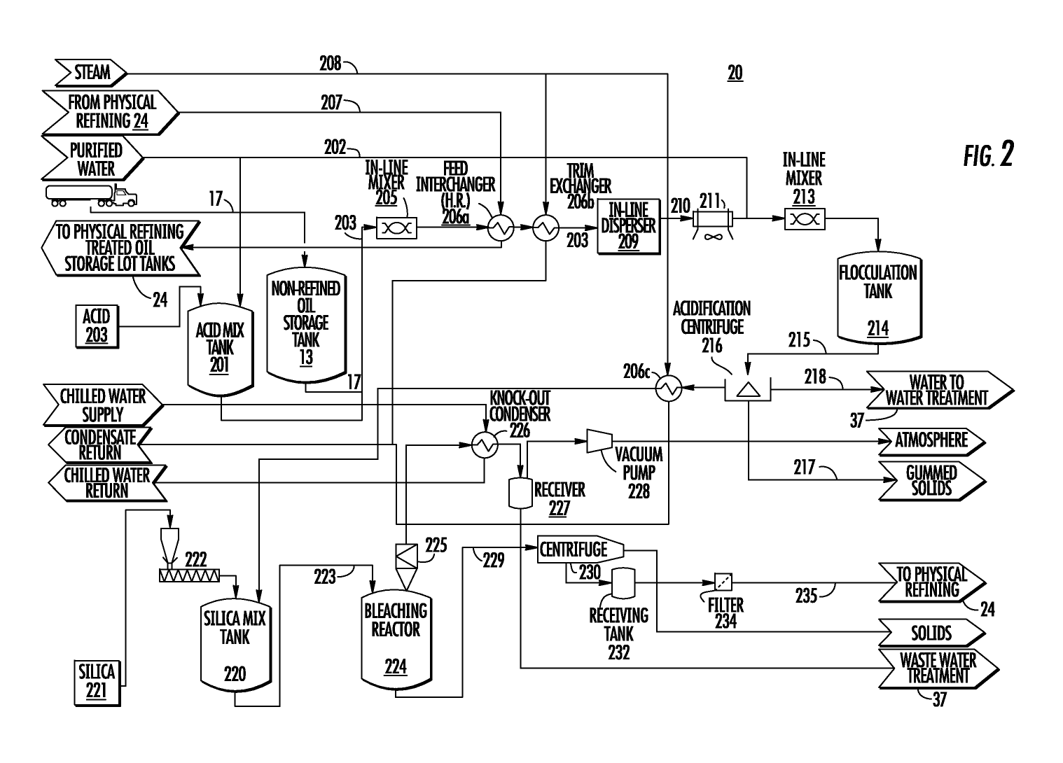

Degumming process 22 can include two stages of acidification separation and bleaching separation, as shown in FIG. 2. In the acidification stage, purified water 202 is acidified with acid 203 in acid mix tank 201. Acid 203 can include one or more of the following acids: citric acid, acetic acid, or phosphoric acid. In acid mix tank 201, the pH of purified water 202 is adjusted to a range of 3 to 7 and is heated to a temperature range of about 40° F. to about 100° F. under atmospheric conditions and is then combined with incoming stream of oil 17 that is to be treated to form mixture 203.

Mixture 203 passes through in-line static mixer 205. Mixture 203 is then heated to a temperature range of about 150° F. to about 200° F. through a series of heat exchangers; feed interchanger 206a and trim exchanger 206b. Feed interchanger 206a can be fired by waste heat 207 from physical refining process 24. Trim exchanger 206b can be a steam fired polishing heat exchanger that is fired with steam 208. Heated mixture 203 then passes through high-shear in-line disperser 209 to reduce the size of the oil droplets in mixture 203 into microscopic particle sizes. Stream 210 leaving in-line disperser 209 passes through air cooled heat exchanger 211 to remove any excess heat that is generated by in-line disperser 209. Purified water 202 is added to stream 210 and mixed in inline-mixer 213 prior to entering flocculation tank 214.

In flocculation tank 214, the acidified oil has a residence time of equal to or greater than 30 minutes to allow the gums to coagulate and to remove a majority of the phospholipids which are not desirable in transesterification process 30. Flocculation tank 214 is gently agitated and operates under atmospheric conditions so as to not break up the agglomerated masses. Oil 215 from flocculation tank 214 passes through acidification centrifuge 216. Acidification centrifuge 216 can be an automated self-cleaning disc bowl centrifuge to remove agglomerated gummy masses 217 from oil 215. Gummy masses 217 adsorb a substantial portion of purified water 202 which was added. Remaining water 218 separated from oil 215 is returned to water treatment process 37 for purification. Oil 215 is then transferred to bleaching stage.

In the bleaching stage, oil 215 is reheated in heat exchanger 206c to a temperature range of about 150° F. to about 200° F. prior to entering silica mix tank 220. In silica mix tank 220, bleaching agent 221 is added through feeder 222 and is dispersed into the solution under atmospheric conditions. A suitable bleaching agent is silica. The federate of bleaching agent 221 is dependent on the amount of impurities in oil 215 which is being treated. Bleaching agent 221 removes the remaining phospholipids and other impurities from oil 215. Once dispersed in silica mix tank 220, stream 223 is transferred to bleaching reactor tank 224. Bleaching reactor tank 224 agitates stream 223 under vacuum between 5 mmHg to 100 mmHg to remove the remaining water under heated conditions. Bleaching reactor tank 224 can include separator 225 on the top vacuum connection to allow droplets of liquid to condense out of the vapor prior to approaching knockout condenser 226. Removed water from knock-out condenser 226 is collected in receiver 227 and is forwarded to water treatment process 37. The vapor outlet of knock-out condenser 226 is connected to vacuum pump 228 which discharges to the atmosphere.

Bleached oil 229 is transferred to decanting centrifuge 230 to remove the spent bleaching agent. The solids are partially dried within decanting centrifuge 230. Bleached oil 229 is then collected in receiving tank 232 and is transferred through filter 234 to remove small particles that passed through decanting centrifuge 230. Degummed oil 235 from filter 234 is transferred to physical refining process 24.

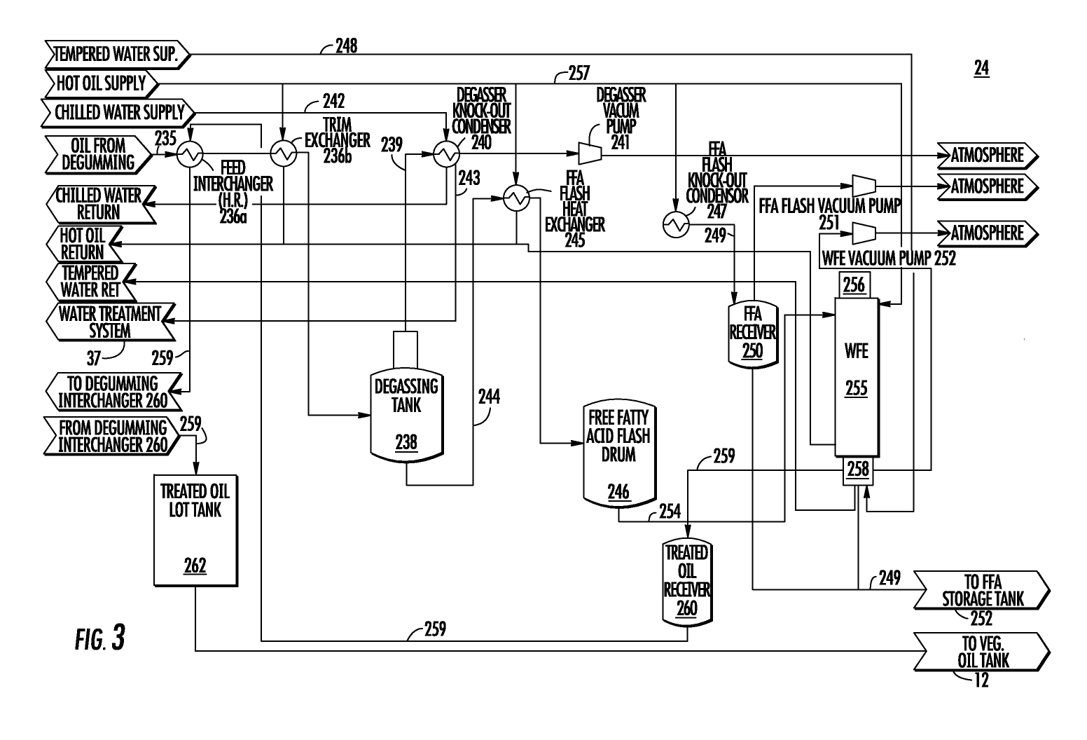

Physical refining process 24 removes free fatty acid (FFA) from degummed oil 235, which is desirable since free fatty acid (FFA) can create unwanted soaps and a rag layer in transesterification process 30. Degummed oil 235 is heated in multiple stages to high temperatures and under vacuum to first remove the residual water from the degumming segment and then the free fatty acid (FFA) prior to being cooled and placed into storage. Free fatty acid (FFA) has a very similar boiling point as that of oil at atmospheric conditions. Deep vacuum conditions are used to create a large enough spread in the boiling points of the two liquid components to allow separation. Degummed oil 235 is heated through a series of heat exchangers; feed interchanger 236a and trim exchanger 236b, as shown in FIG. 3. Feed interchanger 236a is heated with waste heat from stripped oil 259. Trim exchanger 236b can be fired with hot oil to heat degummed oil 235 to a temperature range of about 400° F. to about 480° F. prior to entering degasser tank 238. Degasser tank 238 is operated under vacuum between 20 mmHg to 50 mmHg to remove the residual water which is condensed as vapor stream 239 passes through overhead degasser knock-out condenser 240. Overhead degasser knock-out condenser 240 is cooled with chilled water 242. Condensed water stream 243 from overhead degasser knock-out condenser 240 is sent to water treatment process 37 where it is treated and then reused back into the various processes that use water. The vapor outlet of overhead degasser knock-out condenser 240 is connected to degasser vacuum pump 241.

Oil stream 244 from degasser tank 238 is heated in fired heat exchanger 245 to a temperature range of about 425° F. to about 500° F. prior to entering free fatty acid (FFA) flash drum 246. Heat exchanger 245 can be a hot oil fired heat exchanger. Free fatty acid (FFA) flash drum 246 is operated under vacuum between 1 mmHg and 10 mmHg where a portion of the free fatty acid (FFA) is removed in overhead free fatty acid (FFA) flash knock-out condenser 247. Free fatty acid (FFA) flash knock-out condenser 247 is cooled with cooling media 248, such as tempered water, to the range of about 100° F. to about 150° F. Free fatty acid (FFA) 249 condensate is collected in free fatty acid (FFA) receiver 250 prior to being transferred to free fatty acid (FFA) storage tank 252 for glycerolysis process 30. Free fatty acid (FFA) receiver 250 is connected to free fatty acid (FFA) vacuum pump 251.

Oil 254 from free fatty acid (FFA) flash drum 246 is transferred to wiped film evaporator (WFE) 255. Wiped film evaporator (WFE) 255 is operated under deep vacuum of less than 0.1 mmHg. Wiped film evaporator (WFE) vacuum pump 252 provides the vacuum. Wiped film evaporator (WFE) 255 can have a heating jacket to maintain the temperature range between 425° F. to 500° F. and can use hot oil 257. Agitated wiper blade assembly 256 is located at the top of wiped film evaporator (WFE) 255 and spreads the oil out over the surface to maintain a uniform thin film of liquid on the surface of wiped film evaporator (WFE) 255. As the liquid travels down the inside heated wall of wiped film evaporator (WFE) 255, free fatty acid (FFA) flashes off from oil 254 since it boils at a lower temperature and is condensed on internal condensing coil 258 that has cooling media flowing 248 through it. Cooling media 248 is tempered at an elevated temperature range of 125° F. to 175° F. to prevent the free fatty acid (FFA) from freezing on the condensing coils.

Stripped oil 259 leaves wiped film evaporator (WFE) 255 and is captured in treated oil receiver tank 260. Stripped oil 259 passes through feed interchanger 236a to preheat incoming oil stream 235 from degumming process 22 and then flows to feed interchanger 206a in degumming process 22. Afterwards, stripped oil 259 is transferred to treated oil lot tank 262 where a qualitative analysis is performed prior to transferring stripped oil 259 to feedstock oil tank 12 for transesterification process 30.

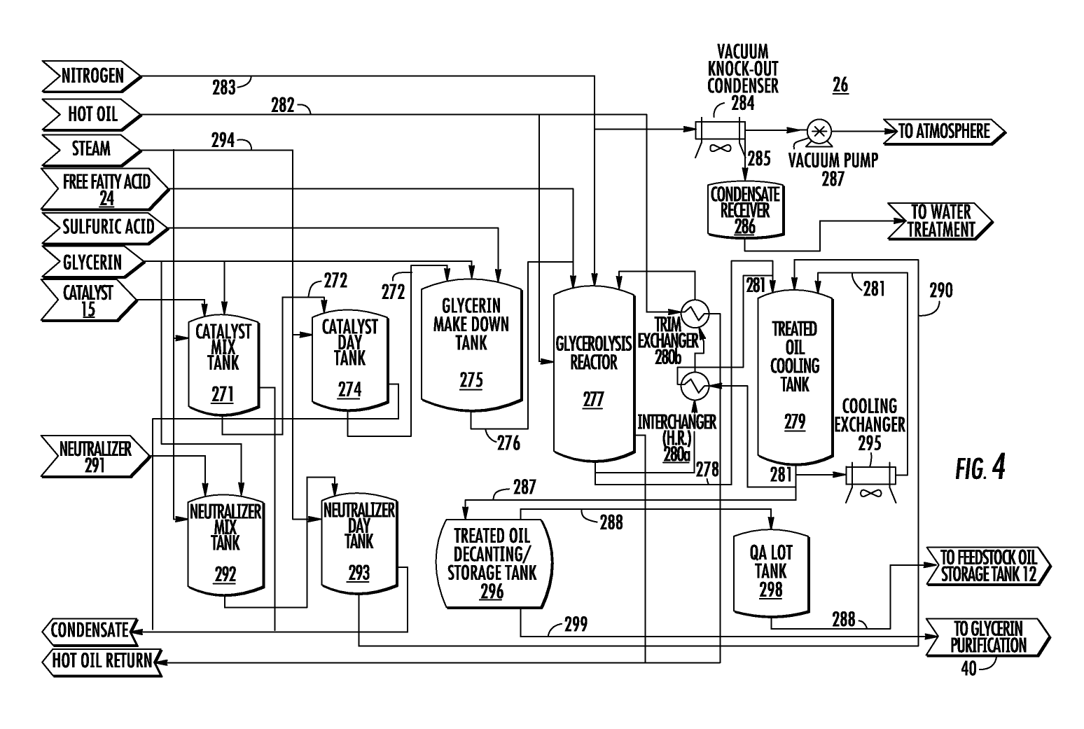

A suitable glycerolysis process 26 is shown in FIG. 4. Free fatty acid (FFA) is esterified by reacting it with acidified glycerin 47 that has passed through part of glycerin purification process 40 that removes solvent, in the presence of a catalyst, for example zinc oxide, at an elevated temperature to convert the free fatty acid (FFA) into mono-glycerides, di-glycerides, and water using the following glycerolysis reaction:

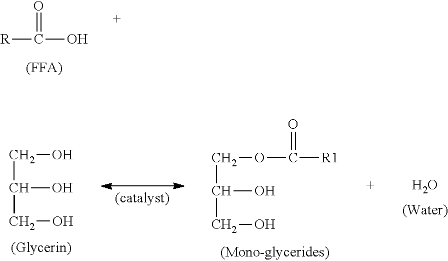

A quantity of glycerin from glycerin flash (GLF) process 44 is transferred to catalyst mix tank 271 where it is heated to enhance dissolving of the catalyst to form catalyst solution 272. Catalyst mix tank 271 can be a jacketed and agitated vessel that is heated with steam. After catalyst solution 272 is prepared in catalyst mix tank 271, it is transferred into catalyst day tank 274. Catalyst day tank 274 can be a jacketed and agitated vessel that is heated with steam. A portion of catalyst solution 272 is then transferred into glycerin make-down tank 275 along with a portion of acid 273 to yield glycerin make-down solution 276. Preferably, sulfuric acid can be used as acid 273. Glycerin make-down solution 276 from glycerin make-down tank 275 is transferred into glycerolysis reactor 277 along with a quantity of free fatty acid (FFA) from physical refining process 24. Solution 278 from glycerolysis reactor 277 is heated through a bank of heat exchangers; interchanger 280a and trim exchanger 280b. Interchanger 280a can be heated with waste heat 281 from treated oil cooling tank 286. As a finished batch is being cooled, the waste heat will first be recovered by interchanger 280a to heat the batch in the glycerolysis reactor 277 with as much waste heat that can be practically be recovered. Trim exchanger 280b can be a hot oil fired polishing heat exchanger which is heated with hot oil 282 to a temperature range between about 450° F. to about 500° F. in glycerolysis reactor 277. Glycerolysis reactor 277 and heat exchanger 280b can have hot oil jackets to maintain the temperature for a time period to allow the conversion of the free fatty acid (FFA) into mono- and di-glycerides.

In glycerolysis reactor 277, the free fatty acid (FFA) will be converted to mono- and di-glycerides along with the creation of water. The water will boil off and be present in the vapor phase in the head space on top of the liquid within glycerolysis reactor 277. The water vapor is removed using nitrogen 283 with a nitrogen sweep into vacuum system 285. Water vapor is condensed 285 in vacuum knock-out condenser 284. The condensed water vapors are collected in condensate receiver 286 and transferred to the water treatment process 37. The vapor outlet is connected to vacuum pump 287 and is vented into the atmosphere.

Once the glycerolysis reaction has been completed, the product is transferred to treated oil cooling tank 279 where the reaction is stopped by adding neutralizing solution 290. Neutralizing solution 290 is made by adding neutralizer 291 to glycerin from glycerin purification process 40 and is heated to mix into solution in neutralizer mix tank 292. Neutralizer mix tank 292 can be a jacketed and agitated vessel that is heated with steam. After neutralizer solution 290 is prepared it is transferred to neutralizer day tank 293. Neutralizer day tank 293 can be a jacketed and agitated vessel that is heated with steam. Waste heat is recovered from treated oil cooling tank 279 by recirculating this hot solution 281 through interchanger 280a, as described previously. Once all particle waste heat is recovered, oil 281 is further cooled down to a safe handling temperature in treated oil cooling tank 279 by circulating it through cooling exchanger 295. Cooling exchanger 295 can be an air-cooled exchanger to minimize the utilities for the cooling services. Cooled oil 287 is transferred to treated oil decanting/storage tank 296. In treated oil decanting/storage tank 296, decanted oil 288 is the top layer and is transferred to QA lot tank 298. A sample is obtained and quality control (QC) tests are performed to ensure that the material meets the feedstock oil requirement. Upon passing the quality control (QC) tests, decanted oil 288 is released to feedstock oil tank 12 for use in transesterification process 30. Decanted glycerin 299 from decanting/storage tank 296 is transferred to glycerin purification system 40 as required or is recycled into glycerine make-down tank 275 if suitable.

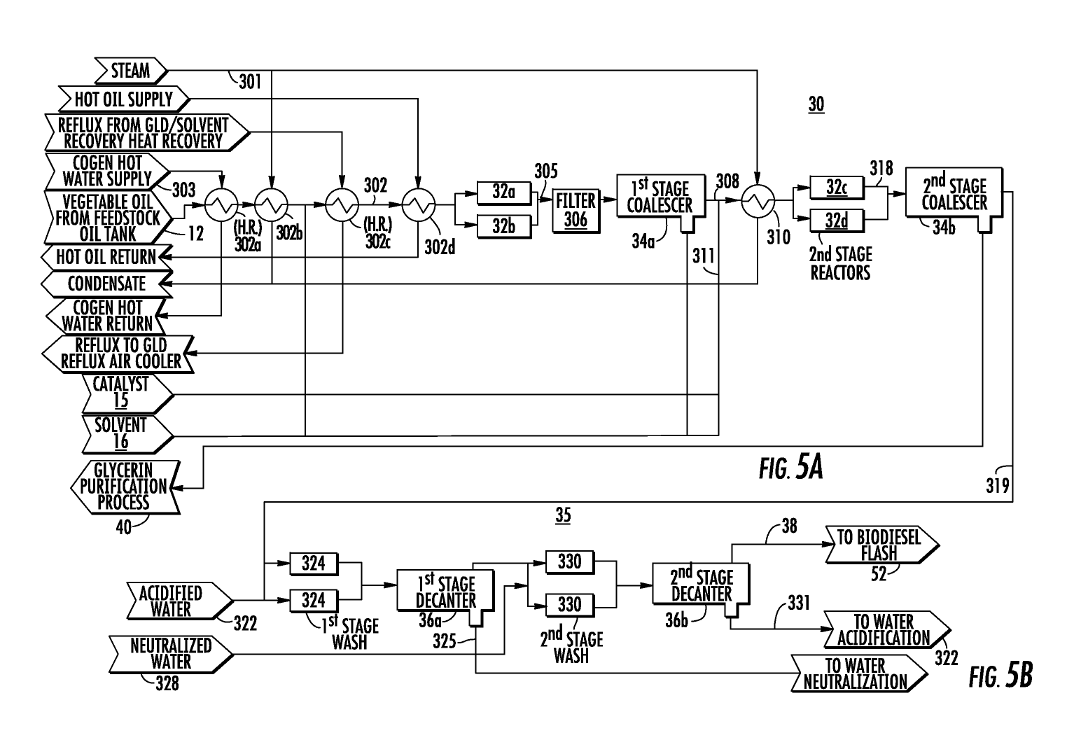

Transesterification process 30 is used to convert various feedstock sources into biodiesel fuel as shown in FIG. 5A. Transesterification process 30 includes washing of the biodiesel product. The transesterification process utilizes the universal chemical equation:

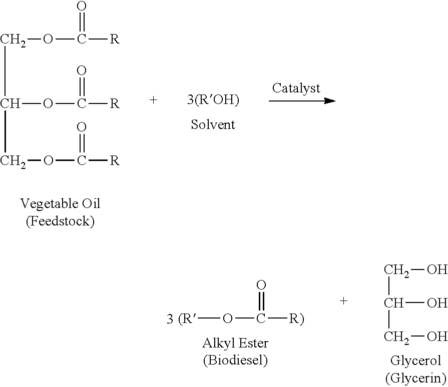

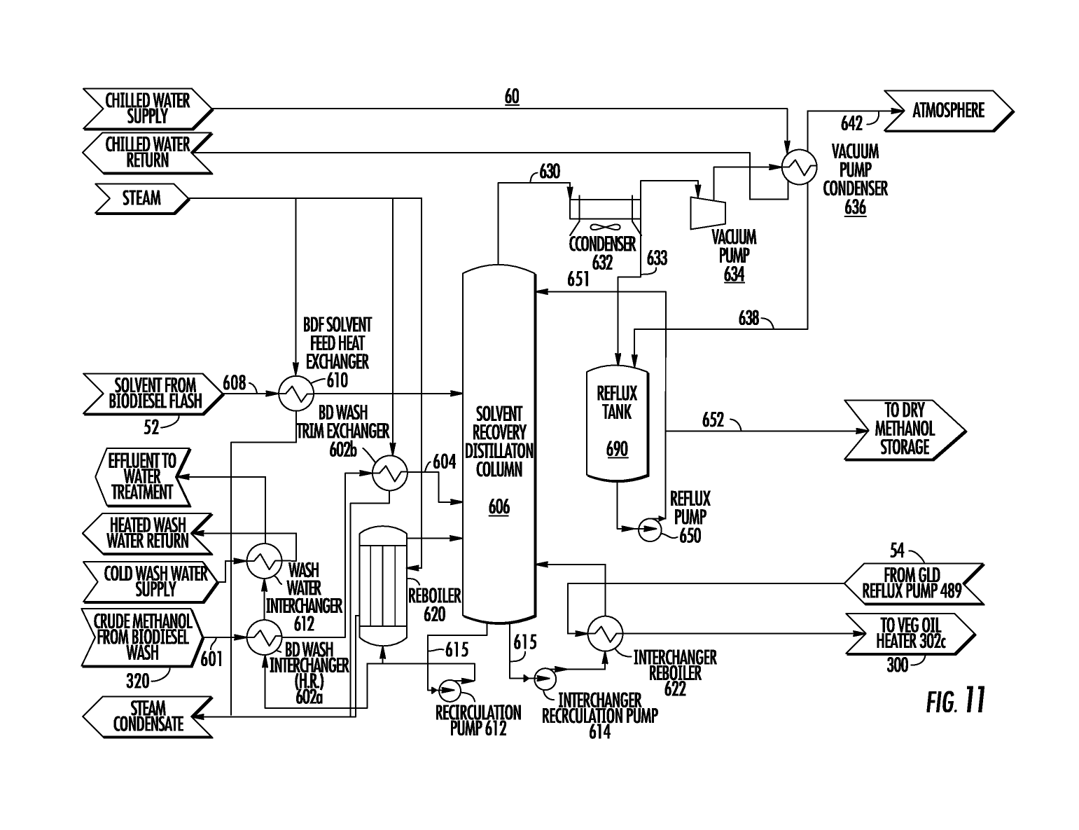

Feedstock from feedstock oil tank 12 is pumped through a set of in-line heat exchangers 302a through 302d that are connected in series to recover as much waste heat from various utility and process operations, as shown in FIG. 5A. Heat exchanger 302a is fired with waste heat 303 from a CoGen hot water system 304. Heat exchanger 302b can be steam fired with steam 301. Heat exchanger 302a and 302b can be located adjacent to feedstock oil tank 12 so that they can be used to heat feedstock oil tank 12 during cold weather. Feedstock oil 29 is combined with catalyst from catalyst storage tank 15 and from solvent storage tank 16 and then flows to the heat exchanger 302c. Heat exchanger 302c is fired with the waste heat from the glycerin distillation reflux after it is used to heat one of the solvent recovery process reboilers 622 in solvent recovery process 60, as shown in FIG. 11. Combined mixture 304 flows to heat exchanger 302d. Heat exchanger 302d can be hot oil fired polishing exchanger to heat the mixture to a temperature range between about 150° F. and about 240° F.

In one embodiment, one mole of oil feedstock oil is combined with catalyst to a molar rate of 0.025 to 0.050, and solvent at a molar rate of 1.5 to 2.5 to drive the transesterification reaction to near completion. A preferred catalyst is sodium methoxide, also referred to as sodium methylate. A preferred solvent is methanol. Combined mixture 304 is mixed in first stage reactors 32a, 32b. First stage reactors 32a, 32b can be plug flow reactors. Reaction product 305 from first stage reactors 32a, 32b is filtered with filter 306 before coalescer 34a. Biodiesel 308 from coalescer 34a is heated with heat exchanger 310. Heat exchanger 310 can be steam fired to bring the temperature back up to the starting temperature of the first stage reactors. Additional catalyst and solvent enters inlet 311 to heat exchanger 310. Biodiesel 308 from heat exchanger 310 is mixed in second stage reactors 32c, 32b. Reaction product 318 from second stage reactors 32c and 32d is received in coalescer 34b. Solvent and catalyst split for first stage reactors 32a, 32b and second stage reactors 32c, 32d are in a range of about 2.5:1 to about 5:1. The velocity of the solution inside first stage reactors 32a, 32b and second stage reactors 32c, 32d the plug flow reactors is between about 2 ft/sec and about 10 ft/sec.

Glycerin is a natural byproduct to the transesterification reaction. For every ten parts of biodiesel formed there is one part of glycerin formed. Glycerin is the heavier of the two phases, thus it flows out of the bottom of coalescers 34a and 34b, and biodiesel flows out of the top. Both phases contain quantities of the solvent, as shown in FIG. 1. Most of the unreacted oil flows with the biodiesel out of the top of coalescers 34a and 34b since they are similar in density and lighter than glycerin. There are trace amounts of unreacted oil carried over in the glycerin phase. The majority of oil feedstock 29 is converted to biodiesel in first stage reactors 32a, 32b and the rest is reacted in second stage reactors 32c, 32d. It is preferred to have a greater portion of catalyst and solvent used in first stage reactors 32a, 32b.

After the transesterification reaction, glycerin from coalescers 34a and 34b is sent to glycerin purification process 40 and the biodiesel is then washed in two-stage washing process 35, as shown in FIG. 5B. Acidified water 322 is added to biodiesel 319 prior to entering first stage wash reactors 324. The acid neutralizes the unreacted catalyst in biodiesel 319 to stop the reaction and the creation of undesirable byproducts. The acidified water from first stage wash reactors 324 is removed from bottom 325 of decanter 36a and is neutralized with neutralized water 328. Neutralized water 328 is used to wash biodiesel 319 in second stage wash reactors 330. The wash water from second stage wash reactors 330 is removed from bottom 331 of decanter 36b and can be reused in first stage wash reactors 324 for creating a closed loop. Unreacted catalyst is converted in to sodium salts and is carried over in mixture 38 and is eventually removed from the solvent in the solvent recovery process 60 as shown in FIG. 1.

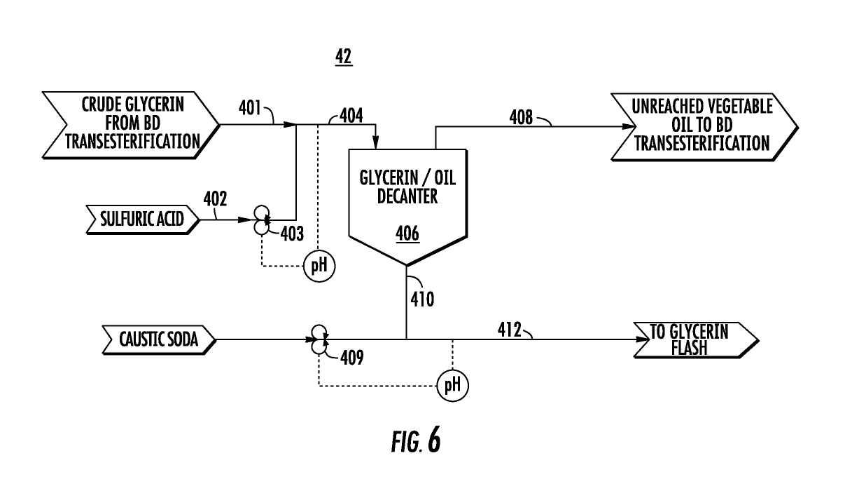

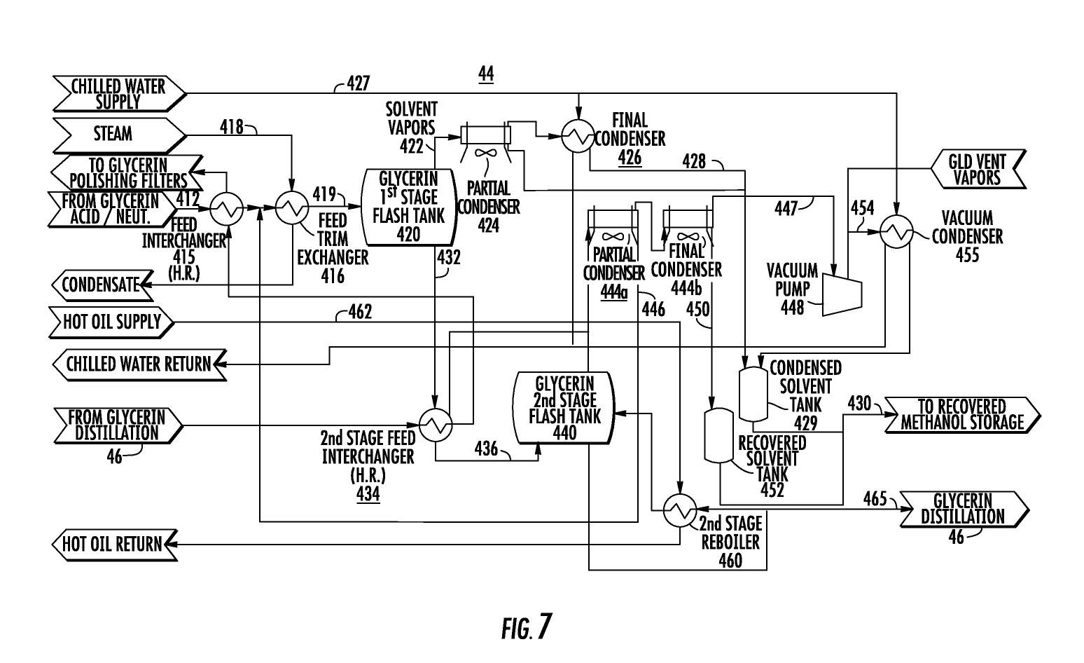

An embodiment of glycerin purification process 40 is illustrated in FIGS. 6 through 8. Glycerin purification process consists of the following steps: glycerin acidulation/neutralization, as shown in FIG. 6; glycerin flash (GLF), as shown in FIG. 7;

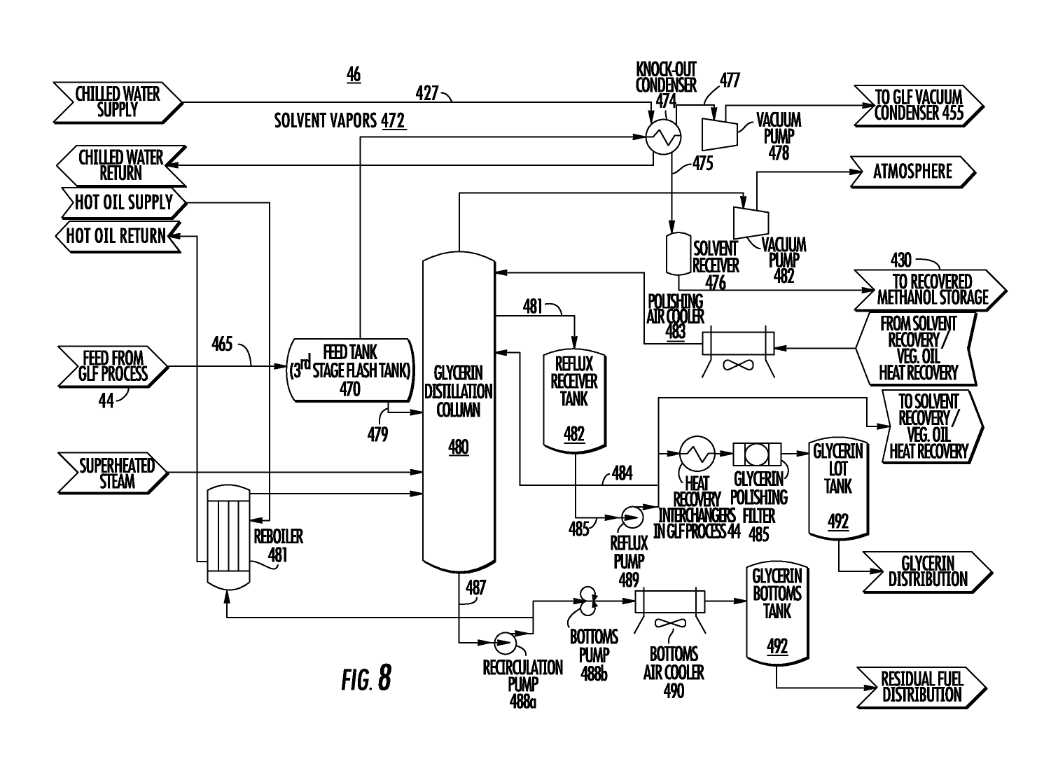

and glycerin distillation (GLD), as shown in FIG. 8.

Crude glycerin 401 flows from the biodiesel transesterification process 30 and is acidified with acid 402 as shown in FIG. 6. A suitable acid 402 can be concentrated sulfuric acid to lower the pH of the crude glycerin between a range of 2 and 5 using pump 403. Acidified glycerin 404 and enters glycerin/oil decanter 406 where unreacted vegetable oil 408 is removed and recycled back into biodiesel transesterification process 30. Glycerin 410 from glycerin/oil decanter 406 is neutralized with caustic soda using pump 409, for example, to bring the pH back to neutral of 7.

Neutralized glycerin 412 enters glycerin flash (GLF) process 44, as shown in FIG. 7. The glycerin flash (GLF) process 44 comprises a two-stage flash tank configuration with the second stage operating at a vacuum to minimize equipment and operating costs.

Neutralized glycerin 412 from glycerin treatment 42 is heated first by waste heat from glycerin distillation (GLD) 46 in feed interchanger 415 and then through feed trim exchanger 416. Feed trim exchanger 416 can be heated with steam 418 to elevate the temperature between the range of about 180° F. to about 230° F. Heated glycerin 419 flows into first stage flash tank 420. A portion of solvent 422 is flashed off into the vapor phase and then flows to a series of condensers to recover the solvent. Solvent 422 flows to partial condenser 424. Partial condenser 424 can be air cooled to minimize the utility load. Vapor from partial condenser 424 passes to final condenser 426. Final condenser 426 can be cooled with chilled water 427 and the vapors are discharged to the atmosphere. Condensate 428 is received in condensed solvent tank 429 and transferred to recovered methanol storage tanks 430.

Liquid glycerin 432 leaving first stage flash tank 420 is heated in second stage feed interchanger 434. Second stage feed interchanger 434 can be heated with recovered heat from glycerin distillation (GLD) system 46 to a temperature range of about 200° F. to about 250° F. Heated glycerin 436 enters the second stage flash tank 440. Second stage flash tank 440 can be operated under a vacuum range of about 5 to about 9 PSIA. The remaining solvent is flashed off in second stage flash tank 440 and condensed in a series of air cooled condensers, partial condenser 444a and final condenser 444b. Condensate 446 from partial condenser 444a is recirculated back to feed trim exchanger 416 prior to first stage flash tank 420. The vapors leaving partial condenser 444a flow into final condenser 444b. Vapors 447 leaving final condenser 444b flows into vacuum pump 448 to operate this stage under vacuum. Condensate 450 from final condenser 444b flows to recovered solvent tank 452. Vapor discharge 454 from vacuum pump 448 passes through vacuum condenser 455. Vacuum condenser 455 can be cooled with chilled water 427. Condensate 456 from vacuum condenser 455 flows into condensed solvent tank 429 for the first stage since they have similar working pressures. Second stage flash tank 440 can be heated with second stage reboiler 460. Second stage reboiler 460 can be heated with hot oil supply 462.

Glycerin distillation (GLD) process 46 comprises a third stage flash tank and distillation column which both operate under vacuum to minimize the capital and operating costs.

Discharge steam 465 of glycerin flash (GLF) process 44 enters third stage flash tank 470, as shown in FIG. 8. Third stage flash tank 470 can operates under a vacuum range between 2 and 4 PSIA. The remaining solvent vapors 472 flash off inside third stage flash tank 470 and pass through knock-out condenser 475. Condensate 474 from knock-out condenser 475 is collected in solvent receiver 476 and returned to recovered methanol storage system 430. Vapors 477 pass through vacuum pump 478 and are directed to vacuum condenser 455 in glycerin flash (GLF) process 44 in FIG. 7, to remove any lingering trace quantities of solvent.

Liquid 479 from third stage flash tank 470 is transferred to the feed tray of glycerin distillation (GLD) column 480. Glycerin distillation (GLD) column 480 can be operated under a vacuum range of 0.15 and 0.5 PSIA, a reflux ratio between 1 to 1 and 6 to 1, and is capable of steam stripping to enhance purification. Liquid 487 leaving the bottom of glycerine distillation (GLD) column 480 passes through the packing and is pumped with recirculation pump 488a around through a hot oil fired reboiler 491 and the glycerin mixture is then returned to the glycerin distillation (GLD) column 480. Superheated steam is added to the bottom of glycerin distillation (GLD) column 480 to provide the steam stripping action. The top of glycerin distillation (GLD) column 480 is connected to vacuum pump 482 which discharges to atmosphere.

Reflux 481 inside of glycerin distillation (GLD) column 480 is routed to reflux receiver tank 482 where reflux contents 485 are pumped with reflux pump 489 to three (3) different uses as described below.

The first stream is the cold reflux that is used as a direct contact condensing media for the top part of glycerin distillation (GLD) column 480. The material is cooled by recovering waste heat through the use of two (2) interchangers. First, in the auxiliary reboiler 622 solvent recovery process 60 shown in FIG. 11 and secondly, in vegetable oil waste heat recovery heater 302c which is installed on the feed line to transesterification process 30 shown in FIG. 5. As the reflux returns, it passes through polishing air cooler 483 prior to entering the top of glycerin distillation (GLD) column 480, as shown in FIG. 8. The second stream is hot reflux 484 which is routed back to the middle portion of glycerin distillation (GLD) column 480. The third stream passes through second stage feed interchanger 434 and feed interchanger 415 of glycerin flash (GLF) process 40 shown in FIG. 7 to recover the waste heat prior to passing through activated polishing filter 485 before entering glycerin lot tank 486, as shown in FIG. 8. Polishing filter 485 can be a carbon filter. Glycerin lot tank 486 can be used for quarantine for QC testing.

Glycerin bottoms 487 from glycerine distillation column 480 can be pumped by recirculation pump 488a and then through bottoms pump 488b to pass through bottoms air cooler 490. Bottoms air cooler 490 can be used to lower the temperature to a safe handling level prior to being dispensed to glycerin bottoms tank 492. This material is designated for residual biodiesel inventory.

Biodiesel purification process 50 includes the steps of biodiesel flash (BDF) in which the vast majority of the solvent is removed from the biodiesel and biodiesel distillation (BDD) in which trace quantities of remaining solvent along with the various impurities are removed preferably to meet the ASTM 6571 quality standard.

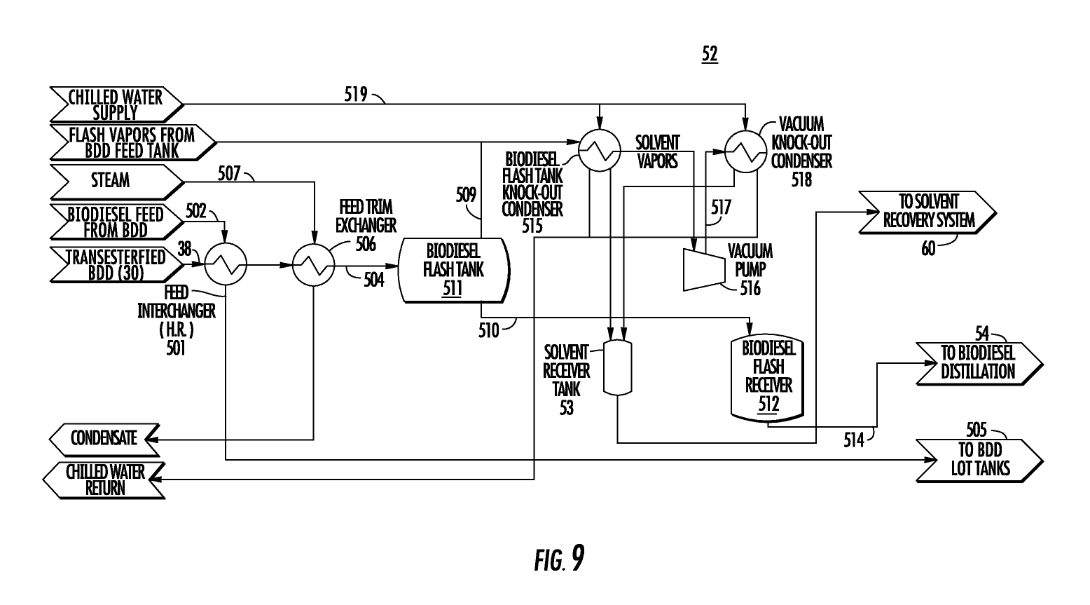

An embodiment of biodiesel flash (BDF) process 52 is shown in FIG. 9 as a single stage evaporator that operates under vacuum to reduce the energy demand to separate the solvent from the biodiesel product. Mixture 38 from transesterification process 30 passes through feed interchanger 501. Feed interchanger 501 can be fired by waste heat from the biodiesel distillation (BDD) process 502. After heating, heated mixture 504 from feed interchanger 501 flows to feed trim exchanger 506. Feed trim exchanger 506 can be fired with steam 507. Feed trim exchanger 506 can be the primary source of heat during start-up of biodiesel purification process 50. Heated mixture 504 from feed trim exchanger 506 enters biodiesel flash (BDF) tank 508. Biodiesel flash (BDF) tank 508 can operate under a vacuum range of 1 to 5 PSIA and a temperature range between about 175° F. and about 235° F. In biodiesel flash (BDF) tank 508, solvent is vaporized and is removed off of top 509 of biodiesel flash (BDF) tank 508. Biodiesel 510 is pumped out of bottom 511 of biodiesel flash (BDF) tank 508 and into biodiesel flash (BDF) receiver 512. Biodiesel flash (BDF) receiver 512 is heated with the waste heat from the biodiesel distillation (BDD) bottoms as described below. Biodiesel flash (BDF) product 514 from biodiesel flash (BDF) receiver 512 is sent to biodiesel distillation (BDD) process 54 for further purification.

Solvent vapors from biodiesel flash (BDF) tank 508 pass through condenser 515 where the solvent vapors are condensed are collected in the solvent receiver tank 53. Condenser 515 is cooled with chilled water supply 519 and is connected to vacuum source 516. Discharge 517 of vacuum source 516 passes through vacuum pump knock-out condenser 518 to remove any trace amounts of solvent and water vapor, which is collected in solvent receiver tank 53. The condensed solvent contains some amount of absorbed water and the sodium salts. This stream is sent to solvent recovery process 60 where it is shown as steam 608 in FIG. 11.

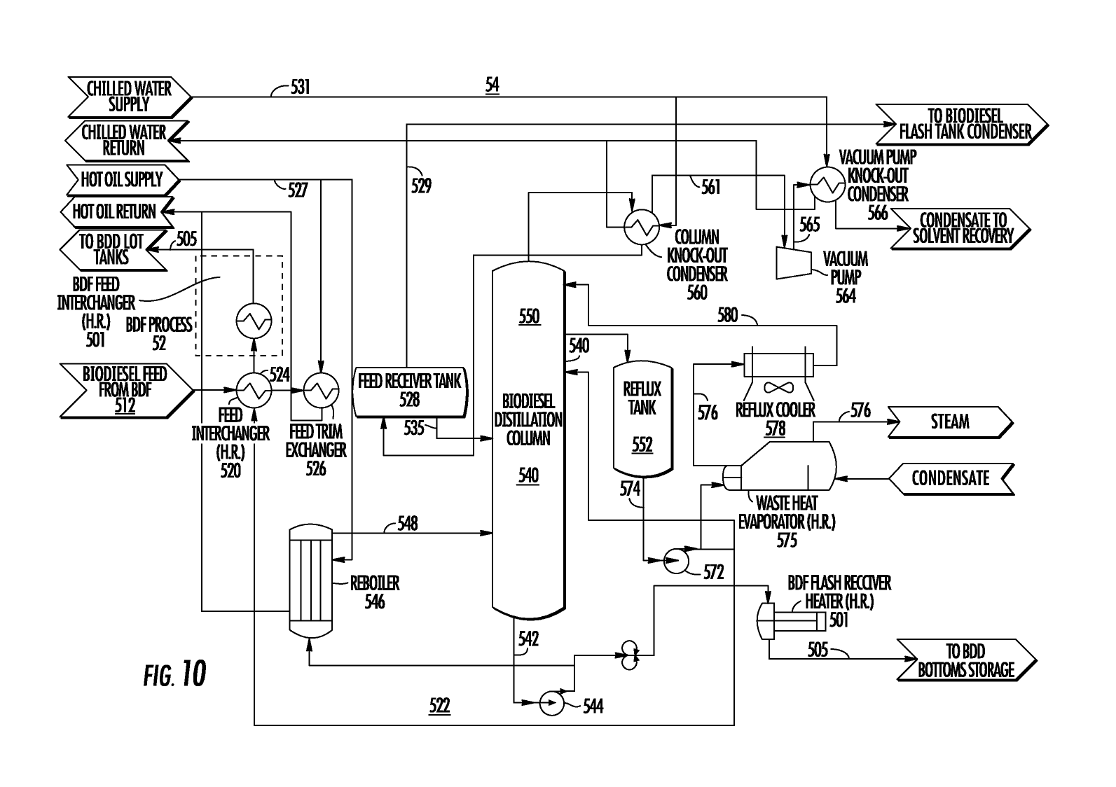

An embodiment of biodiesel distillation (BDD) process 54 is illustrated in FIG. 10 as a continuous vacuum distillation process that is designed to remove the impurities to meet the ASTM 6751 standards.

Biodiesel feed from biodiesel flash (BDF) process 52 received in flash receiver 512 are pumped into feed interchanger 520. Feed interchanger 520 can be fired with the hot biodiesel distillation (BDD) product stream 522. Biodiesel feed 524 from feed interchanger 520 passes through feed trim exchanger 526. Feed trim exchanger 526 can be hot oil fired with hot oil supply 527 before entering feed receiver tank 528 to heat the feed to a temperature range between about 350° F. and about 425° F. Feed receiver tank 528 can be under a vacuum range between 2 and 5 PSIA.

The heating of biodiesel feed 524 allows the remaining solvent to be flashed off when it enters feed receiver tank 528. Solvent vapors 529 from feed receiver tank 528 flows to biodiesel flash tank knock-out condenser 515 in biodiesel flash (BDF) process 52 and are captured in solvent receiver tank 532.

Heated biodiesel flash (BDF) feed 535 from feed receiver tank 528 is then transferred to the feed tray in biodiesel distillation (BDD) column 540. Biodiesel distillation (BDD) column 540 can operate at a reflux ratio range between 1 to 1 and 6 to 1 while under a vacuum range of 0.5 to 2 PSIA. Biodiesel feed 535 enters biodiesel distillation (BDD) column 540 and flows downwards through the packing and is then recirculated as steam 542 by biodiesel column recirculation pump 544 through hot oil fired reboiler 546 to a temperature range of about 450° F. to about 500° F. Reboiler 546 can be heated with hot oil supply 527. Exiting reboiler steam 548 is partially vaporized as it leaves reboiler 546 and enters biodiesel distillation (BDD) column 540. The vapors are in condensed upper section 550 of biodiesel distillation (BDD) column 540 and collected into reflux tank 552. The remaining overhead vapors of biodiesel distillation (BDD) column 540 can be condensed in column knock-out condenser 560 and the condensate is returned to the feed receiver tank 528. Vapor outlet line 561 from column knock-out condenser 560 is connected to vacuum pump 564. Discharge 565 from vacuum pump 564 passes through vapor knock-out condenser 566 to remove the remaining solvent. Column knock-out condenser 560 and vacuum knock-out condenser 566 can be cooled with chilled water supply 531.

Reflux 570 collected from upper section 550 of biodiesel distillation (BDD) column 540 flows into reflux tank 552 where it is distributed in multiple streams. A portion of hot biodiesel distillation (BDD) product 522 from reflux tank 552 is circulated with pump 572 back to feed interchanger 520 to preheat the incoming biodiesel feed stream from biodiesel flash (BDF) process 52. Then the exiting stream from feed interchanger 520 flows to feed interchanger 501 in biodiesel flash (BDF) process 52 before entering biodiesel lot storage tanks 505, as shown in FIG. 9. A second stream of hot biodiesel distillation (BDD) product flows into middle section 574 of biodiesel distillation (BDD) column 540 for further purification. A third portion of biodiesel distillation (BDD) product 522 from reflux tank 552 is circulated as heating media through waste heat recovery evaporator 575 to make low pressure process steam 576 from the collected steam condensate. The steam is then distributed in the plant steam distribution system. Discharge 576 from waste heat recovery evaporator 575 passes through a reflux air cooler 578 to ensure that the temperature is low enough to be used as contact media 580 for direct contact condenser in upper section 550 of biodiesel distillation (BDD) column 540.

An embodiment of solvent recovery process 60 is shown in FIG. 11. Solvent recovery process 60 is operated under vacuum to minimize energy and equipment costs. Solvent recovery process 60 can operate at a reflux ratio range between 1 to 1 and 6 to 1.

There are two feed streams for solvent recovery process 60; biodiesel wash feed stream and biodiesel flash fed stream. The first feed stream is solvent discharge feed 601 from biodiesel wash process 35, shown in FIG. 5B. Solvent discharge feed 601 passes through biodiesel wash interchanger 602a and biodiesel wash trim exchanger 602b, as shown in FIG. 11. Biodiesel wash interchanger 602a recovers the waste heat from the bottoms water discharge 615 from solvent recovery distillation column 606. Biodiesel wash trim exchanger 602b can be a steam fired polishing exchanger to heat feed 601 to a temperature range of about 150° F. to about 210° F. Heated feed 604 enters a lower column feed tray of solvent recovery distillation column 606.

The second feed stream is solvent discharge feed 608 from biodiesel flash (BDF) process 52. Solvent discharge feed 608 passes through biodiesel flash (BDF) solvent feed heat exchanger 610. Biodiesel flash (BDF) solvent feed exchanger 610 can be a steam fired heat exchanger that heats solvent discharge feed 608 to a temperature range between about 130° F. and about 170° F. Solvent discharge feed 608 enters the upper column feed tray of solvent recovery distillation column 606. The liquid travels down to the bottom where it is collected and recirculated by recirculation pumps 612 and 614.

Recirculation pump 612 passes liquid 615 from solvent recovery distillation column 606 through a parallel bank of heat exchangers. A first bank cools the effluent water steam. First bank includes interchanger 602a to preheat the incoming mixed solvent/water stream from the biodiesel flash (BDF) process and heat exchanger 602b to heat this stream to a temperature range between about 150° F. and about 210° F. This steam then enters into the bottom feed plate of solvent recovery distillation column 606. The first bank also includes interchanger 612 to heat the cold wash water for transesterification process 30. The discharging effluent water stream from interchanger 612 is directed to water treatment system 37 at a temperature range between about 65° F. and about 75° F.

A second bank includes reboiler 620. Reboiler 620 can be a steam fired reboiler that heats liquid 615 to a temperature range of about 175° F. to about 240° F. and then returns liquid 215 to the bottom of solvent recovery distillation column 606.

Interchanger recirculation pump 614 passes liquid 615 from solvent recovery distillation column 606 to interchanger reboiler 622. Interchanger reboiler 622 can be fired by the waste heat from glycerin reflux stream that is being cooled for use as the contact condensing media at the top of the glycerin distillation (GLD) column 480, as shown in FIG. 8. The solvent is heated to a temperature range of about 175° F. to about 240° F. The discharge of that waste heat stream is then directed to feedstock preheater 302c after the addition of catalyst and solvent for the first stage reactor of the transesterification process 300, as shown in FIG. 5.

As the solvent is boiled by the reboilers, vapors 630 travel upwards through solvent recovery distillation column 606, as shown in FIG. 11. Solvent recovery distillation column 606 can operate under a vacuum range between 9 and 14 PSIA. Vapors 630 from solvent recovery distillation column 606 flow into air cooled condenser 632. Condensate 633 from air cooled condenser 632 flows to reflux tank 690. The vapor discharge from condenser 632 passes through vacuum pump 634. The discharge vapors from vacuum pump 634 pass through a chilled water cooled condenser 636 where condensate 638 is directed to reflux tank 640 and vapors 642 are vented to the atmosphere. Reflux portion 651 from reflux tank 640 is pumped by reflux pump 650 back to the top of the solvent recovery distillation column 606. Reflux portion 652, the remaining portion, is pumped to dry methanol storage.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for the production of biodiesel comprising the steps of:
receiving refined natural oil, unrefined natural oil, recovered vegetable oil, and animal fats;
pretreating the recovered vegetable oil and the animal fats, said pretreating step comprises degumming for removing impurities except free fatty acid (FFA) from the recovered vegetable oil and the animal fats; physical refining for removing the free fatty acid (FFA) by heating the recovered vegetable oil and the animal fats and pulling vacuum; and glycerolysis for converting the free fatty acid (FFA) from the physical refining step into a single methyl ester (SME);
combining the single methyl ester (SME) with the refined natural oil and unrefined natural oil to form a combined oil feedstock;
continuous transesterification of the combined oil feedstock by reacting the combined feedstock oil with a catalyst and a solvent to the produce biodiesel and glycerin; and
separating the biodiesel from the glycerin.

2. The method of claim 1 wherein the degumming step comprises acidification separation and bleaching separation, in the acidification separation the acid can include one or more acids selected from citric acid, acetic acid, and phosphoric acid and in the bleaching separation silica is used as a bleaching agent.

3. The method of claim 3 wherein after the acidification separation further comprising the step of micronizing the recovered vegetable oil and animal fats to reduce the size of oil droplets into microscopic particle sizes.

4. The method of claim 4 further comprising the step of removing gummed solids before the bleaching separation.

5. The method of claim 1 further comprising the step of washing the separated biodiesel, the washing step comprising adding acidified water to the biodiesel prior to entering a first stage wash reactor and after the first stage adding neutralized water to wash the biodiesel in a second stage and removing the water from the biodiesel.

6. The method of claim 5 further comprising the step of treating the water removed from the biodiesel and returning the water to the washing step.

7. The method of claim 5 wherein the acid in the acidified water is sulfuric acid.

8. The method of claim 1 further comprising the step of purifying the glycerin, the step of purifying the glycerin comprises the steps of glycerin acidulation/neutralization, glycerin flash (GLF), and glycerin distillation (GLD), wherein the glycerin acidulation/neutralization comprises adding an acid to the glycerin from the transesterification and recycling unreacted vegetable oil to the transesterification process and neutralizing the glycerin before the glycerin flash (GLF) and wherein the glycerin flash (GLF) flashes the solvent from the glycerin before the glycerin distillation (GLD) and the glycerin distillation (GLD) removes solvent remaining after the glycerin flash (GLF).

9. The method of claim 1 wherein in the transesterification, the catalyst is sodium methoxide and the solvent is an alcohol.

10. The method of claim 9 wherein the solvent is methanol.

11. The method of claim 1 further comprising the step of purifying the biodiesel, the step of purifying the biodiesel from the transesterification comprising biodiesel flash (BDF) and biodiesel distillation (BDD), wherein the biodiesel flash (BDF) flashes the solvent from the biodiesel before the biodiesel distillation (BDD) and the biodiesel distillation (BDD) removes solvent remaining after the biodiesel flash (BDF).

12. The method of claim 1 wherein the glycerolysis comprises reacting the free fatty acid (FFA) in the presence of a catalyst with the glycerin from the transesterification which has been acidified, the glycerol is converts the free fatty acid (FFA) into mono-glycerides, diglycerides and water.

13. The method of claim 12 wherein the catalyst is zinc oxide.

14. The method of claim 11 further comprising recovering the solvent from the solvent removed in the biodiesel flash (BDF) and using the recovered solvent in the transesterification.

15. The method of claim 1 wherein in the physical refining step the degummed oil from the degumming step is heated in a plurality of stages, the first stage is used to first remove residual water from the degummed oil and the second stage is used to remove the free fatty acid (FFA), in the first stage a degasser tank operated under vacuum removes the residual water and in the second stage a free fatty acid (FFA) flash drum operated under vacuum removes a portion of the free fatty acid (FFA) and remaining oil and free fatty acid (FFA) in the flash drum is transferred to a wiped film evaporator (WFE) for stripping the oil from the free fatty acid (FFA).

16. The method of claim 15 wherein the oil from the wiped film evaporator (WFE) is used as heat in the plurality of stages in the physical refining step.

17. The method of claim 1 wherein waste heat in the physical refining step is used in the degumming step.

18. A system for the production of biodiesel from a starting feed of refined natural oil, unrefined natural oil, recovered vegetable oil, and animal fats comprising;
means for pretreating the recovered vegetable oil and the animal fats, said pretreating comprises means for degumming for removing impurities except free fatty acid (FFA) from the recovered vegetable oil and the animal fats; means for physical refining for removing the free fatty acid (FFA) by heating the recovered vegetable oil and the animal fats and pulling vacuum; and means for glycerolysis for converting the free fatty acid (FFA) from the physical refining into a single methyl ester (SME);
means for continuous transesterification of a combined oil feedstock of the single methyl ester (SME) with the refined natural oil and unrefined natural oil to form a combined oil feedstock by reacting the combined feedstock oil with a catalyst and a solvent to the produce biodiesel and glycerin; and
means for separating the biodiesel from the glycerin.

19. The system of claim 18 further comprising:
means for purifying the glycerin including means for glycerin acidulation/neutralization, glycerin flash (GLF) and glycerin distillation (GLD).

20. The system of claim 18 further comprising means for purifying the biodiesel from the transesterification comprising biodiesel flash (BDF) and biodiesel distillation (BDD), wherein the biodiesel flash (BDF) flashes the solvent from the biodiesel before the biodiesel distillation (BDD) and the biodiesel distillation (BDD) removes solvent remaining after the biodiesel flash (BDF).

21. The system of claim 18 wherein the means for physical refining comprises a plurality of stages to heat the degummed oil from means for degumming, the first stage is used to first remove residual water from the degummed oil and the second stage is used to remove the free fatty acid (FFA), in the first stage a degasser tank operated under vacuum removes the residual water and in the second stage a free fatty acid (FFA) flash drum operated under vacuum removes a portion of the free fatty acid (FFA) and remaining oil and free fatty acid (FFA) in the flash drum is transferred to a wiped film evaporator (WFE) for stripping the oil from the free fatty acid (FFA).
